(19) United States
(12) Patent Application Publication
(10) Pub. No.: US 2019/0210928 A1
(43) Pub. Date: Jul. 11, 2019

(54) CERAMIC COMPONENT AND METHOD OF FORMING SAME

(71) Applicant: SAINT-GOBAIN CERAMICS & PLASTICS, INC., Worcester, MA (US)

(72) Inventors: Stephen BOTTIGLIERI, Northbridge, MA (US); VIDAR JOHANNESSEN, Kristiansand (NO); Nabil NAHAS, Mougins (FR); STEPHEN D. HARTLINE, Shrewsbury, MA (US)

(21) Appl. No.: 16/335,127

(22) PCT Filed: Sep. 30, 2016
(86) PCT No.: PCT/US2016/054637

§ 371 Date: Mar. 20, 2019

(51) Int. Cl. C04B 35/575; C04B 35/626; C04B 35/634; C04B 35/632; C04B 35/645

(52) U.S. Cl. CPC C04B 35/575; C04B 2235/786; C04B 35/63416; C04B 35/63488; C04B 35/6325; C04B 35/62655; C04B 35/645; C04B 35/62695; C04B 2235/383; C04B 2235/3418; C04B 2235/3217; C04B 2235/5445; C04B 2235/5436; C04B 2235/6567; C04B 2235/87; C04B 2235/96; C04B 35/6264

(57) ABSTRACT

A body including a first phase having silicon carbide, a second phase comprising a metal oxide, the second phase being a discrete intergranular phase located at the grain boundaries of the first phase, and the body has an average strength of at least 700 MPa.

### TECHNICAL FIELD

The following is directed to bodies including silicon carbide, blends of powder materials used for forming such bodies, and methods of forming such bodies.

### BACKGROUND ART

Various composite materials are commercially available, including certain ceramic composite bodies incorporating silicon carbide. Silicon carbide-based ceramic materials have been utilized in many applications for their refractory properties and/or mechanical properties. Among the types of silicon carbide-based ceramics available, various types exist based on the particular forming process, including for example, sintered silicon carbide, hot pressed silicon carbide, and recrystallized silicon carbide. Each of the various types of silicon carbide bodies can have distinct features. For example, sintered silicon carbide (such as Hexoloy®) can be a very dense material, but is generally expensive and complex to produce. On the other hand, more cost effective but relatively porous silicon carbide materials such as nitride-bonded silicon carbide (known by acronyms such as NBSC and NSIC) have found practical use in refractory applications. Such refractory components include furnace or kiln furniture utilized in connection with holding or supporting work pieces during firing operations, as well as refractory lining materials. Nitride-bonded silicon carbide tends to be a comparatively porous material, oftentimes having a porosity within a range of about 10 to about 15 vol %. These components are manufactured from a green body containing silicon carbide and silicon, and sintering the green body in a nitrogen containing atmosphere at temperatures on the order of 1,500° C. While nitride-bonded silicon carbide has desirable high temperature properties, it unfortunately suffers from poor oxidation resistance when used in oxidizing conditions, due in part to its intrinsic porosity.

In view of the state of the art of silicon carbide-based materials, there is a need in the art for improved materials.

### SUMMARY

According to one aspect, a body includes a first phase comprising silicon carbide, a second phase comprising a metal oxide, wherein the second phase is a discrete intergranular phase located at the grain boundaries of the first phase, and wherein the body comprises an average strength of at least 700 MPa.

In another aspect, a body includes a first phase comprising silicon carbide and having an average grain size of not greater than 2 microns, and a second phase comprising a metal oxide, wherein the second phase is a discrete intergranular phase located at the grain boundaries of the first phase, and wherein the body comprises at least one of: (i) a second phase count index of at least 1000/100 microns image width; (ii) a second phase average area index of at least 2000 pixels/100 microns image width; (iii) a second phase average size index of at least 3.00 pixels²; (iv) or any combination thereof.

In another aspect, a body includes a first phase comprising silicon carbide and having an average grain size of not greater than 2 microns, and a second phase comprising a metal oxide, wherein the second phase is a discrete intergranular phase and a majority of the second phase is located at triple boundary regions between three or more grains of the first phase. In still another aspect, a method of forming a body includes obtaining a blend of powder material comprising (i) a first powder material comprising silicon carbide and (ii) a second powder material comprising a metal oxide, and wherein the method further includes sintering the blend of powder material to form a body comprising: (i) a first phase comprising silicon carbide and (ii) a second phase comprising a metal oxide, wherein the second phase is a discrete intergranular phase located at the grain boundaries of the first phase, and wherein the body comprises an average strength of at least 700 MPa.

### BRIEF DESCRIPTION OF THE DRAWINGS

FIG. 1 includes a flow chart for forming a body including silicon carbide according to an embodiment.

FIG. 2 includes a scanning electron microscope (SEM) image at a magnification of approximately for a portion of a body according to an embodiment.

FIG. 3 includes a SEM image of a portion of a body according to an embodiment.

FIG. 4 includes a SEM image of a portion of a body according to an embodiment.

FIGS. 5A-5H include cross-sectional SEM images taken from samples formed according to the examples.

FIG. 6 includes a plot of the second phase count index versus strength for samples formed according to the examples.

FIG. 7 includes a plot of second phase average area index versus strength for samples formed according to the examples.

FIG. 8 includes a SEM photomicrograph having 6 horizontal lines used to measure the average grain size according to an embodiment.

### DETAILED DESCRIPTION OF THE PREFERRED EMBODIMENT(S)

The following is directed to blends of powder materials, methods of forming bodies including silicon carbide, and bodies including silicon carbide. The bodies can include ceramic materials, including for example, silicon carbide, which may be used in a variety of applications, including for example, but not limited to refractories, sliding components or wear-resistance components (e.g., bearings, seals, valves), mechanical components, corrosion resistant components, and the like.

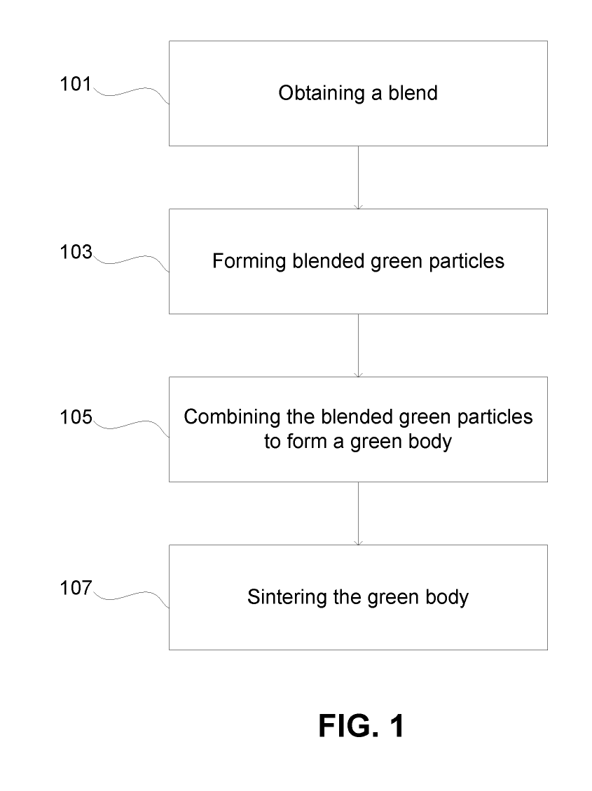

FIG. 1 includes a flow chart for forming a body including silicon carbide according to an embodiment. As illustrated, the process is initiated at step 101, which include obtaining a blend of powder material. According to one aspect, the blend of powder material can include a first powder material comprising silicon carbide and a second powder material comprising a metal oxide. Obtaining the blend may include forming the blend or sourcing the blend from a supplier.

The first powder material including silicon carbide may have a particular average particle size that facilitates formation of a body having certain features as noted in the embodiments herein. For example, the first powder material can have an average particle size of not greater than 1.5 microns, such as not greater than 1.3 microns or not greater than 1 micron or not greater than 0.8 microns or not greater than 0.5 microns or not greater than 0.3 microns or not greater than 0.2 microns or not greater than 0.1 microns. Still, in one non-limiting embodiment, the first powder material can have an average particle size of at least 0.01 microns, such as at least 0.05 microns or at least 0.08 microns or at least 0.1 microns or at least 0.2 microns or at least 0.3 microns or at least 0.4 microns or at least 0.5 microns. It will be appreciated that the average particle size of the first powder material can be within a range including any of the minimum and maximum values noted above.

According to one embodiment, the first powder material can also have a particular maximum particle size, which may be controlled to facilitate suitable processing and formation of the body. The maximum particle size is generally measured via laser light scattering particle size analyzer and use data from the analyzer to identify the D100 value of the particle size distribution, which is the maximum particle size. For one embodiment, the first powder material can have a maximum particle size of not greater than 5 microns, such as not greater than 4.5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.5 microns or not greater than 0.2 microns. Still, in one non-limiting embodiment, the first powder material can have a maximum particle size of at least 0.01 microns, such as at least 0.05 microns or at least 0.08 microns or at least 0.1 microns or at least 0.2 microns or at least 0.5 microns or at least 0.8 microns or at least 1 micron or at least 1.5 microns or at least 2 microns or at least 2.5 microns or at least 3 microns or at least 3.5 microns. It will be appreciated that the maximum particle size of the first powder material can be within a range including any of the minimum and maximum values noted above.

According to one embodiment, the first powder material may have a particular composition, which may be controlled to facilitate suitable processing and formation of the body. For example, the first powder material may include alpha-phase silicon carbide. More particularly, in at least one embodiment, the first powder material can include at least 80 wt % of alpha-phase silicon carbide, such as at least 82 wt % or at least 85 wt % or at least 87 wt % or at least 90 wt % or at least 92 wt % or at least 95 wt % or at least 97 wt % or at least 99 wt % alpha phase silicon carbide. In at least one embodiment, the first powder material can consist essentially of alpha-phase silicon carbide. Reference herein to a composition consisting essentially of a given material can include other materials in trace or impurity contents that do not materially affect the properties of the composition. For example, non-limiting examples of impurity contents of materials can include not greater than 0.1 wt % for a total weight of the composition, such as not greater than 0.08 wt % or not greater than 0.06 wt % or no greater than 0.04 wt % or even not greater than 0.02 wt % for a total weight of the composition.

Moreover, according to one embodiment, the first powder material can include a limited content of beta-phase silicon carbide, such as not greater than 20 wt % for a total weight of the first powder material, or not greater than 18 wt % or not greater than 16 wt % or not greater than 14 wt % or not greater than 12 wt % or not greater than 10 wt % or not greater than 8 wt % or not greater than 6 wt % or not greater than 4 wt % or not greater than 2 wt % or not greater than 1 wt % or not greater than 0.5 wt % or not greater than 0.1 wt % of the total weight of the first powder material. According to one embodiment, the first powder material can be essentially free of beta-phase silicon carbide. Reference herein to a composition that is essentially free of a given material will be understood to be reference to a composition that may include some trace or impurity contents of the given material.

In one particular embodiment, the first powder material is made of particles, and at least a portion of the particles can include an oxidation layer overlying at least a portion of the exterior surfaces of the particles. Without wishing to be tied to a particular theory, it is thought that the presence of the oxidation layer on the particles of the first powder material may facilitate suitable processing and formation of the bodies according to embodiments herein. The oxidation layer can include an oxide compound. In one embodiment, the oxidation layer may include silicon. For example, the oxidation layer may include silicon oxide, such as SiOx, wherein “x” has a value within a range between 1 and 3.

According to one embodiment, the oxidation layer may be present in a particular content relative to the total weight of the first powder material. For example, in at least one instance, the oxidation layer may be present in an average amount of at least 0.01 wt %, such as at least 0.05 wt % or at least 0.08 wt % or at least 0.1 wt % or at least 0.15 wt % or at least 0.2 wt % or at least 0.3 wt % or at least 0.5 wt %. Still, in another non-limiting example, the oxidation layer may be present in an amount of not greater than 5 wt % relative to the total weight of the first powder material, such as not greater than 4 wt % or not greater than 3 wt % or not greater than 2 wt % or not greater than 1.5 wt % or not greater than 1 wt %. It will be appreciated that the content of the oxidation layer relative to the total weight of the first powder material can be within a range including any of the minimum and maximum values noted above.

In at least one embodiment, the portion of the particles including the oxidation layer can include at least 10 wt % of the total weight of particles of the first powder material. In still other instances, the percentage of particles including the oxidation layer can be greater, such as at least 20 wt % or at least 30 wt % or at least 40 wt % or at least 50 wt % or at least 60 wt % or at least 70 wt % or at least 80 wt % or at least 90 wt % for the total weight of particles of the first powder material. In one particular embodiment, essentially all of the particles of the first powder material include the oxidation layer.

As noted herein, the blend of powder material can include a second powder material, which is distinct from the first powder. In certain instances, the second powder material can have a particular average particle size, which can be controlled to facilitate suitable processing and formation of the bodies according to the embodiments herein. For example, the second powder material can have an average particle size of not greater than 1 micron, such as not greater than 0.9 microns or not greater than 0.8 microns or not greater than 0.7 microns or not greater than 0.6 microns or not greater than 0.5 microns or not greater than 0.4 microns or not greater than 0.3 microns or not greater than 0.2 micron or not greater than 0.1 microns. Still, in one non-limiting embodiment, the second powder material can have an average particle size of at least 0.01 microns, such as at least 0.05 microns or at least 0.08 microns or at least 0.1 microns. It will be appreciated that the second powder material can have an average particle size within a range including any of the minimum and maximum values noted above.

According to another embodiment, the second powder material can have a particular maximum particle size, which may be controlled to facilitate suitable formation of a body having the features noted in the embodiments herein. For example, the second powder material can have a maximum particle size of not greater than 5 microns, such as not greater than 4.8 microns or not greater than 4.5 microns or not greater than 4.2 microns or not greater than 4 microns or not greater than 3.8 microns or not greater than 3.5 microns or not greater than 3.2 microns or not greater than 3 microns or not greater than 2.8 microns or not greater than 2.5 microns or not greater than 2.2 microns or not greater than 2 microns or not greater than 1.8 microns or not greater than 1.5 microns or not greater than 1.2 microns or not greater than 1 micron or not greater than 0.9 microns or not greater than 0.8 microns or not greater than 0.7 microns or not greater than 0.6 micron or not greater than 0.5 microns. Still, in one non-limiting embodiment, the second powder material can have a maximum particle size of at least 0.1 microns or at least 0.2 microns or at least 0.3 microns or at least 0.4 microns or at least 0.5 microns or at least 0.6 microns or at least 0.7 microns or at least 0.8 microns or at least 0.9 microns or at least 1 micron. It will be appreciated that the second powder material can have a maximum particle size within a range including any of the minimum and maximum values noted above. The maximum particle size of the second powder material can be measured in the same manner used to measure the maximum particle size of the first powder material.

According to one aspect, the second powder material can include at least one material of the group aluminum, a rare earth element, alkaline earth element, transition metal oxide, or any combination thereof. In still other instances, the metal oxide of the second powder material can include silicon. For example, the metal oxide of the second powder material can include silica. According to one particular embodiment, the metal oxide of the second powder material can include an aluminosilicate. The composition of the second powder material can be controlled to facilitate suitable formation of a body having the features noted in the embodiments herein.

Still, in more particular embodiments, the metal oxide of the second powder material can include alumina. For example, the metal oxide of the second powder material can include at least 50 wt % alumina for the total weight of the second powder material, such as at least 60 wt % alumina or at least 70 wt % alumina or at least 80 wt % alumina or at least 90 wt % alumina or at least 95 wt % alumina or at least 99 wt % alumina for the total weight of the second powder material. In at least one embodiment, the metal oxide of the second powder material may include only alumina, such that the metal oxide can consist essentially of alumina.

The blend of powder material may be formed to include a particular content of the first powder material and the second powder material, which may facilitate suitable formation of a body having the features of the embodiments herein. In certain instances, the blend may include a particular ratio (C1/C2), which is a ratio of the content (wt %) of the first powder material (C1) and the content (wt %) of the second powder material (C2). For example, the blend can have a ratio (C1/C2) of at least 9 or at least 12 or at least 14 or at least 16 or at least 18 or at least 20 or at least 22 or at least 24 or at least 26 or at least 28. Still, in another non-limiting embodiment, the ratio (C1/C2) can be not greater than 99, such as not greater than 97 or not greater than 95 or not greater than 93 or not greater than 90 or not greater than 88 or not greater than 85 or not greater than 82 or not greater than 80 or not greater than 75 or not greater than 70 or not greater than 65 or not greater than 60 or not greater than 55 or not greater than 50 or not greater than 45 or not greater than 40 or not greater than 35 or not greater than 30 or not greater than 28 or not greater than 26 or not greater than 24 or not greater than 22. It will be appreciated that the ratio (C1/C2) can be within a range including any of the minimum and maximum values noted above.

The blend of powder material may be formed to include a particular content of the first powder material, which may facilitate suitable formation of a body having the features of the embodiments herein. For example, the blend can include at least 70 wt % of the first powder material for the total weight of the blend, such as at least 75 wt % or at least 80 wt % or at least 85 wt % or at least 90 wt % or at least 92 wt % or at least 93 wt % or at least 94 wt % or at least 95 wt % or at least 96 wt % or at least 98 wt % of the first powder material for the total weight of the blend. In still one non-limiting embodiment, the blend can include not greater than 99 wt % of the first powder material for the total weight of the blend, such as not greater than 98 wt % or not greater than 97 wt % or not greater than 96 wt % or not greater than 95 wt % or not greater than 94 wt % or not greater than 93 wt % or not greater than 92 wt % or not greater than 91 wt % of the first powder material for the total weight of the blend. It will be appreciated that the content of the first powder material can be within a range including any of the minimum and maximum percentages noted above.

The blend may include a particular content of the second powder material, which may facilitate formation of a body according to the embodiments herein. For example, the blend can include at least 1 wt % of the second powder material for the total weight of the blend, such as at least 2 wt % or at least 3 wt % or at least 4 wt % or at least 5 wt % or at least 6 wt % or at least 7 wt % or at least 8 wt % or at least 9 wt % of the second powder material for the total weight of the blend. In yet another non-limiting embodiment, the blend can include not greater than 10 wt % of the second powder material for the total weight of the blend, such as not greater than 9 wt % or not greater than 8 wt % or not greater than 7 wt % or not greater than 6 wt % or not greater than 5 wt % or not greater than 4 wt % or not greater than 3 wt % or not greater than 2 wt % of the second powder material for the total weight of the blend. It will be appreciated that the content of the first powder material can be within a range including any of the minimum and maximum percentages noted above.

After obtaining the blend at step 101, the process can continue at step 103, which includes forming blended green particles. The process of forming blended green particles can include forming agglomerate particles from the blend of powder material, wherein each of the green particles includes a substantially homogenous mixture including the first and second powder materials. The content of the first and second powder materials in each of the blended green particles can correspond to the contents of the first and second powder materials in the blend. One suitable method for forming the blended green particles can include creating a slurry including the blend of powder material and a carrier material. The carrier material can be a liquid, which may be an organic or inorganic material. In one embodiment, the carrier material can be an aqueous-based material or an organic-based material. For example, one suitable carrier material can include water.

Certain additives may be added to the slurry, including for example, binders, stabilizers, surfactants, rheology modifiers, dispersants, and the like. Typical binders can include organic materials, such as polyvinyl alcohols (PVA), polyethylene glycol (PEG), latex, or any combination thereof. Such additives are typically present in minor amounts, such as less than 20 wt % for the total weight of the dry powder mixture (i.e., materials without the carrier material).

According to one particular embodiment, some suitable dispersants can include Ammonia, ammonia derivatives, ammonium compounds of methacrylates and carboxylates, alkali hydroxides, or any combination thereof.

After forming the slurry, the process can include mixing the slurry to facilitate formation of a homogenous distribution of the first and second powder materials throughout the slurry. According to one embodiment, mixing may include milling, such as attrition milling or ball milling.

After sufficiently mixing the slurry, the process may continue by forming the slurry into the blended green particles. One particularly suitable process for converting the slurry to the blended green particles can include spray drying. The spray drying process can be conducted under conditions suitable to form blended green particles having a finely controlled particle size distribution. Some screening or sieving may be conducted on the blended green particles to produce particles having a controlled particle size distribution. In particular, it may be suitable to remove large particles, such as agglomerates of a certain size.

According to one embodiment, the blended green particles can have an average particle size of at least 20 microns and not greater than 200 microns. For example, the average particle size of the blended green particles can be not greater than 180 microns, such as not greater than 160 microns or not greater than 150 microns or not greater than 140 microns or not greater than 120 microns or not greater than 100 microns or not greater than 80 microns or not greater than 60 microns or not greater than 40 micron. Still, in one non-limiting embodiment, the average particle size of the blended green particles can be at least 40 microns or at least 60 microns or at least 80 microns or at least 100 microns or at least 120 microns. It will be appreciated that the average particle size of the blended green particles can be within a range including any of the minimum and maximum values noted above. The average particle size of the blended green particles can be measured in the same manner used to measure the average particle size of other powder materials as noted herein. For example, the average particle size can be the D50 value generated by suitable sampling and analysis of the particulate via a laser light scattering particle size analyzer.

Moreover, the blended green particles may have a maximum particle size of not greater than 200 microns, such as not greater than 180 microns, such as not greater than 160 microns or not greater than 150 microns or not greater than 140 microns or not greater than 120 microns or not greater than 100 microns or not greater than 80 microns. Still, in one non-limiting embodiment, the maximum particle size of the blended green particles can be at least at least 60 microns or at least 80 microns or at least 100 microns or at least 120 microns. It will be appreciated that the maximum particle size of the blended green particles can have a maximum particle size within a range including any of the minimum and maximum values noted above. The maximum particle size of the blended green particles can be measured in the same manner used to measure the average particle size of other powder materials as noted herein.

The process for forming the blended green particles may further include a drying process, wherein after forming the blended green particles, such particles undergo some drying to remove excess liquid and undesired volatile species.

After forming the blended green particles at step 103, the process can continue at step 105 by combining the blended green particle to form a green body. Reference herein to a green body is reference to an undensified or unsintered part. Some suitable processes for forming the green body can include pressing, punching, molding, casting, extruding, curing, or any combination thereof.

After forming the green body at step 105, the green body can be sintered using heat treatment to densify and form the final body. In certain instances, the process for forming the green body and the sintering process can be combined. For example, in at least one embodiment, the blend of green particles can be placed in a mold of desired shape, and placed in a container for pressing and sintering, such that the finally-formed sintered body is formed in a single step. Still, other processes may form a green body first and conduct a separate sintering process after forming the green body. In certain instances, the sintering process may include a pressure-assisted sintering process, such as hot pressing (i.e., uniaxial pressing), spark plasma sintering, flash sintering, hot isostatic pressing, and the like. Still, in other instances, the sintering process may be a pressure-less process, wherein sintering is conducted without additional or external pressure.

According to one embodiment, the sintering process can include pressureless sintering or pressure-assisted sintering. In one particular embodiment, the sintering process can include hot pressing, which can be a uniaxial pressing operation, which includes the application of force at elevated temperatures to facilitate densification. Alternatively, one may use hot isostatic pressing (HIPing), wherein the green body is subject to high temperatures suitable for sintering in a sealed container, which also creates higher than atmospheric pressures on the body during the sintering operation.

In certain instances, the hot pressing operation can include applying a particular sintering pressure, which is the maximum applied pressure on the body during the maximum sintering temperature. Control of the sintering pressure can facilitate formation of a body having the features of the embodiments herein. For example, the sintering pressure can be at least 2000 psi, such as at least 2500 psi or at least 3000 psi. Still, in at least one non-limiting embodiment, the sintering pressure may be not greater than 5000 psi, such as not greater than 4000 psi or not greater than 3000 psi. It will be appreciated that the sintering pressure can be within a range including any of the minimum and maximum values noted above.

In addition to controlling the sintering pressure, the duration of the applied pressure may also be controlled to facilitate formation of a body having the features of the embodiments herein. For example, according to one embodiment, hot pressing can include applying the sintering pressure for a duration of at least 0.5 hours. The duration of the sintering pressure will be understood to be the duration of the maximum applied pressure at the maximum sintering temperature during hot pressing. In another embodiment, the duration for application of the sintering pressure can be at least 1 hour or at least 2 hours or at least 3 hours or at least 4 hours. Still, in at least one non-limiting embodiment, the duration that the sintering pressure is applied may be not greater than 5 hours, such as not greater than 4 hours or not greater than 3 hours. It will be appreciated that the duration of the sintering pressure can be within a range including any of the minimum and maximum values noted above.

According to one embodiment, the process of hot pressing can be conducted at a particular sintering temperature, which can be the maximum sintering temperature used to form the finally-formed body. In at least one embodiment, the sintering temperature can be at least 1900° C., such as at least 1920° C. or at least 1950° C. In one non-limiting embodiment, the sintering temperature can be not greater than 2100° C., such as not greater than 2080° C. or not greater than 2050° C. It will be appreciated that the sintering temperature can be within a range including any of the minimum and maximum values noted above.

The atmosphere during sintering may be controlled to facilitate suitable formation of the body having the features of the embodiments herein. For example, sintering may be conducted in an inert atmosphere, such as a noble gas. In one embodiment, sintering can be conducted in an atmosphere including argon, such that it may consist essentially of argon. In other instances, sintering may be conducted in an atmosphere containing normal atmospheric gases. In still another embodiment, the atmosphere during sintering may be a reducing atmosphere.

After conducting the sintering operation, the green body is converted to a finally-formed body. The body may be cooled from the sintering temperature using standard techniques. The finally-formed body can have one or more features of the embodiments herein as noted in the following.

The body can be formed into any shape suitable for the intended end use. For example, the body may be shaped in the form of an annulus or cylinder in the context of wear-resistant components. The body may have a length, width and height, wherein the length ≥width ≥height. The body can have a two-dimensional shape as defined by the plane of the length and width that may be a regular polygon, an irregular polygon, an irregular shape, a complex shape including a combination of linear and curved portions, and the like. Similarly, the body can have a two-dimensional shape as defined by the plane of the length and height that can be a regular polygon, an irregular polygon, an irregular shape, a complex shape including a combination of linear and curved portions, and the like. Moreover, the body can have a two-dimensional shape as defined by the plane of the width and height that can be a regular polygon, an irregular polygon, an irregular shape, a complex shape including a combination of linear and curved portions, and the like. The body can have any shape suitable for use in protective components which may be in the form of vehicle parts or body parts, cones (blasting cones), and the like.

According to one aspect, the body can include a first phase comprising silicon carbide and a second phase comprising a metal oxide. In at least one embodiment, the first phase can include alpha-phase silicon carbide, such as 6H alpha-phase silicon carbide. For at least one embodiment, at least 98% of the first phase can include alpha-phase silicon carbide. In a more particular embodiment, the first phase of the body can consist essentially of alpha-phase silicon carbide. In certain instances, the first phase can be essentially free of beta-phase silicon carbide. In at least one embodiment, the body may include not greater than 0.1 wt % beta-phase silicon carbide for the total weight of the body.

Certain embodiments may include a body having a particular content of the first phase, which may facilitate certain properties and/or performance of the body. For example, the body can include at least 70 wt % of the first phase for the total weight of the body. In other instances, the amount of the first phase within the body can be greater, such as at least 75 wt % or at least 80 wt % or at least 85 wt % or at least 90 wt % or at least 92 wt % or at least 93 wt % or at least 94 wt % or at least 95 wt % or at least 96 wt % for the total weight of the body. In one non-limiting embodiment, the body can include not greater than 99 wt % of the first phase for the total weight of the body, such as not greater than 98 wt % or not greater than 97 wt % or not greater than 96 wt % or not greater than 95 wt % or not greater than 94 wt % or not greater than 93 wt % or not greater than 92 wt % or not greater than 91 wt % of the first phase for the total weight of the body. It will be appreciated that the amount of the first phase within the body can be within a range including any of the minimum and maximum values noted above.

According to another embodiment, the body may be formed to have a particular average grain size of the first phase, which may facilitate certain properties and/or performance of the body. For example, the first phase may have an average grain size of not greater than 2 microns as measured according to the intercept method. In other embodiments, the average grain size of the first phase can be less, such as not greater than 1.8 microns or not greater than 1.5 microns or not greater than 1.3 microns or not greater than 1 micron or not greater than 0.8 microns or not greater than 0.5 microns. Still, in one non-limiting embodiment, the first phase can have an average grain size of at least 0.1 microns, such as at least 0.2 microns or at least 0.4 microns or at least 0.6 microns or at least 0.8 microns or at least 1 micron. It will be appreciated that the average grain size of the first phase can be within a range including any of the minimum and maximum values noted above.

The average grain size (i.e., average crystallite size) is measured based on the intercept method using scanning electron microscope (SEM) photomicrographs. Samples are mounted in epoxy resin then polished with diamond polishing slurry using a polishing unit. The polished samples are mounted on the SEM mount then gold coated for SEM preparation.

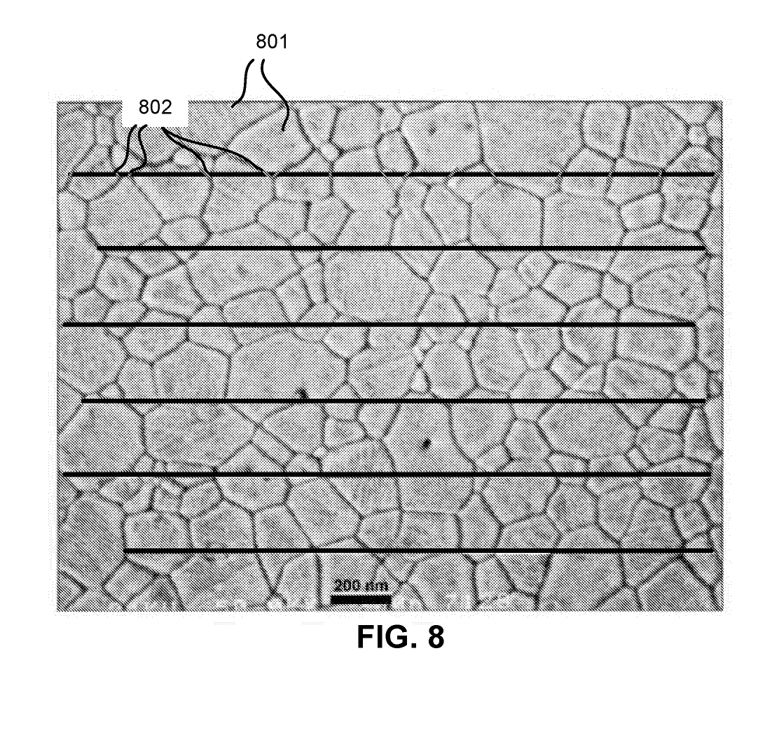

SEM photomicrographs of three or more individual samples are taken at a reasonable magnification to clearly resolve the microstructure and grains in each of the samples. Each of the SEM photomicrographs are analyzed according to the following technique: 1) 6 horizontal lines are drawn across the image, excluding black data band at bottom of photomicrographs (See, FIG. 8) 2) For each of the 6 horizontal lines, the points at which each of the lines crosses a grain boundary of the grains 801, such as points 802, are marked, and two immediately adjacent points 802 define a line segment of the horizontal line; 3) an imaging program or a program within imaging software, such as ImageJ, is used to measure the line segment lengths for each of the lines segments in each of the 6 horizontal lines; 4) in the case of pores or other defects, such feature are excluded from measurements; 5) the data is then tabulated and placed in a spreadsheet or other program to analyze the average grain size (D50), which is the average line segment length for all of the samples evaluate. It will be appreciated that such measurements may also be used to determine the maximum grain size, which can be the D100 or largest measured grain size from the analysis.

Additionally, the body can be formed to have a particular maximum grain size, which may facilitate certain properties and/or performance of the body. For example, the first phase can have a maximum grain size of not greater than 10 microns, such as not greater than 9 microns or not greater than 8 microns or not greater than 7 microns or not greater than 6 microns or not greater than 5 microns or not greater than 4 microns or not greater than 3 microns or not greater than or not greater than 2.5 microns or not greater than 2 microns or not greater than 1.5 microns or not greater than 1 micron. In one non-limiting embodiment, the first phase can have a maximum grain size of at least 0.51 microns or at least 0.6 microns or at least 0.7 microns or at least 0.8 microns or at least 0.9 microns or at least 1 micron or at 1.2 microns or at least 1.4 micron or at least 1.5 microns or at least 1.6 microns or at least 1.8 microns or at least 2 microns. It will be appreciated that the maximum grain size of the first phase can be within a range including any of the minimum and maximum values noted above. The maximum grain size can be measured using the same technique used to measure average grain size, but the value is based on the largest line segment length measured.

As noted herein, the body can include a second phase that is distinct from the first phase. The second phase can include a different material and may be positioned in a different region of the body compared to the first phase. In one particular embodiment, the second phase includes a metal oxide, and more particularly, may include at least one composition such as aluminum, a rare earth element, alkaline earth element, transition metal oxide, or any combination thereof. In certain instances, the content and composition of the metal oxide material may facilitate suitable processing (e.g., sintering) and formation of a second phase located at certain regions within the body. In at least one embodiment, the metal oxide of the second phase can include alumina. In one embodiment, the second phase can consist essentially of alumina.

The metal oxide of the second phase may have a particular structure, which may facilitate certain properties and/or performance of the body. For example, the first phase may be at least one of a crystalline phase (e.g., polycrystalline), or a combination thereof. In at least one embodiment, the first phase may consist essentially of a crystalline phase. In another embodiment, the first phase may consist essentially of an amorphous phase. For yet another aspect, the first phase may include some amorphous phase and crystalline phases.

The amorphous phase and crystalline phase may include the same composition of metal oxide, such as aluminum and silicon, or more particularly an alumina-based phase. For example, in certain instances, the metal oxide of the second phase comprises aluminum and silicon and the second phase comprises a first portion including a crystalline phase and a second portion comprising an amorphous phase, both including the aluminum and silicon. In at least one embodiment, the second phase consists essentially of crystalline (e.g., polycrystalline) alumina, including only impurity contents of any other materials. Trace or impurity contents do not materially affect the properties of the material, and may be present in contents not greater than 0.1 wt % or not greater than 0.05 wt % or not greater than 0.01 wt % for the total weight of the material. The same definitions apply to any other materials described herein as consisting essentially of a material, such that the object contains only that material and only trace amounts or impurity contents of other species.

In at least one aspect, the metal oxide of the second phase can include a particular content of alumina (Al₂O₃). For example, the metal oxide of the second phase can include at least 50 wt % alumina, such as at least 60 wt % alumina or at least 70 wt % alumina or at least 80 wt % alumina or at least 90 wt % alumina or at least 95 wt % alumina or even at least 99 wt % alumina. In at least one embodiment, the metal oxide of the second phase can consist essentially of alumina. Still, in one non-limiting embodiment, the metal oxide of the second phase may include not greater than 99.5 wt % alumina, such as not greater than 99 wt % or not greater than 98 wt % or even not greater than 97 wt %. It will be appreciated that the content of alumina in the metal oxide of the second phase can be within a range including any of the minimum and maximum percentages noted above.

In certain instances, some materials may be intentionally excluded from the second phase. Accordingly, it is within the scope of at least one embodiment to form a body, wherein the metal oxide of the second phase is essentially free of alkali elements, alkaline earth elements, transition metal elements, rare earth elements (including yttrium and lanthanum) or any combination thereof.

The body may be formed to include a certain content of the second phase, which may facilitate improved properties and/or performance. For example, the body may include at least 1 wt % of the second phase for the total weight of the body, such as at least 2 wt % or at least 3 wt % or at least 4 wt % or at least 5 wt % or at least 6 wt % or at least 7 wt % or at least 8 wt % or at least 9 wt % of the second phase for the total weight of the body. In one non-limiting embodiment, the body may include not greater than 10 wt % of the second phase for the total weight of the body, such as not greater than 9 wt % or not greater than 8 wt % or not greater than 7 wt % or not greater than 6 wt % or not greater than 5 wt % or not greater than 4 wt % or not greater than 3 wt % or not greater than 2 wt % of the second phase for the total weight of the body. It will be appreciated that the content of the second phase within the body can be within a range including any of the minimum and maximum percentages noted above.

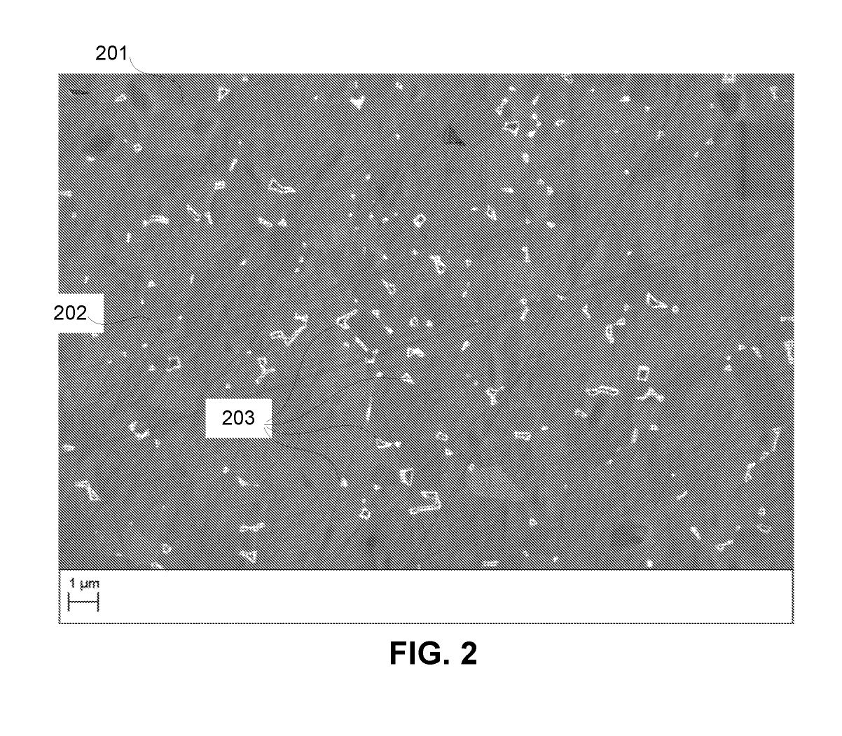

According to one particular embodiment, the second phase can be located within specific regions of the body and define a particular microstructure and morphology. FIG. 2 includes a scanning electron microscope (SEM) image at a magnification of approximately for a portion of a body according to an embodiment. As depicted in FIG. 2, the body 201 can include a first phase 202 and a second phase 203. The second phase 203 is depicted by the discrete white regions between the regions of the first phase 202, wherein the first phase 202 is depicted as the matrix material having a grey color. According to one embodiment, the second phase can be a discrete intergranular phase located at the grain boundaries of the first phase. In more particular instances, a majority of the second phase 203 within the body 201 can be located at triple boundary regions between three or more grains of the first phase 202. For example, according to one embodiment, at least 55% of the second phase 203 can be located at triple boundary regions between three or more grains of the first phase 202, such as at least 60% or at least 70% or at least 80% or at least 90% or at least 95% of the second phase 203 can be located at triple boundary regions between three or more grains of the first phase 202. In still more particular instances, essentially all of the second phase 203 can be located at triple boundary regions between three or more grains of the first phase 202. Still, in one non-limiting embodiment, not greater than 99% of the second phase 203 may be located at triple boundary regions between three or more grains of the first phase 202.

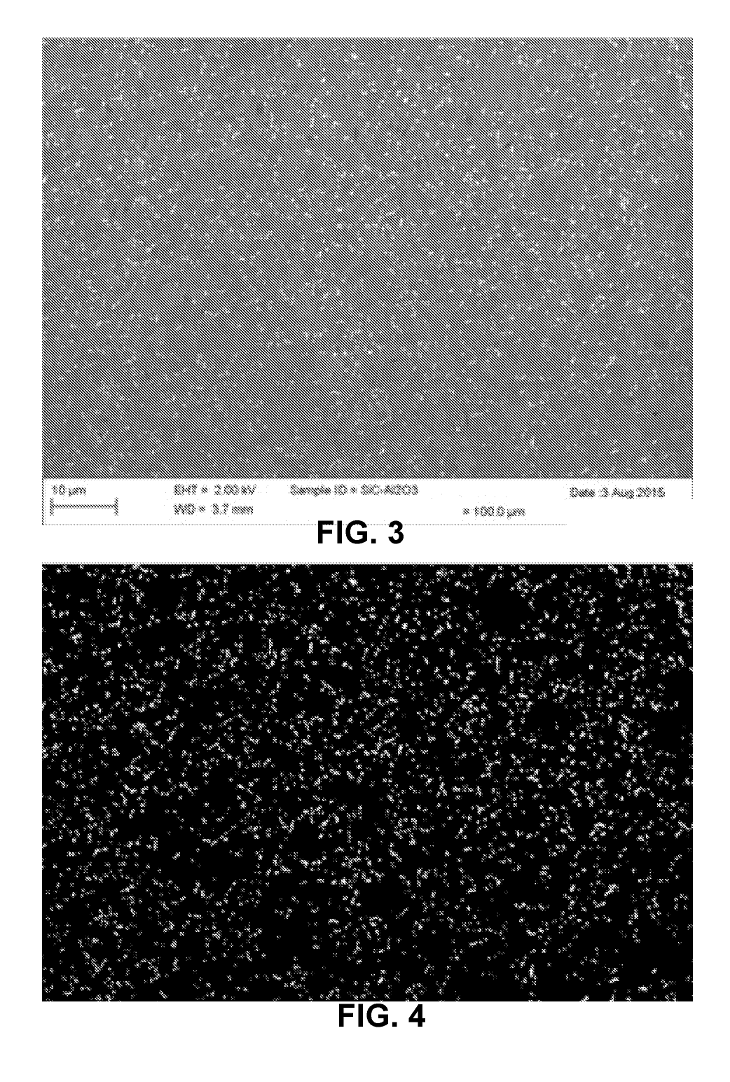

Moreover, according to another embodiment, the body may be formed to have a particular microstructure that facilitates certain properties of the body as described in the embodiments herein. Notably, the microstructure may have a particular content, distribution and/or size associated with the second phase, which may facilitate the properties of the embodiments herein. For example, in at least one embodiment, the body can have a second phase count index of at least 1000/100 microns of image width, based on a the SEM image having a total of 100 microns. In still another case such as at least 1100/100 microns image width or at least 1200/100 microns image width or at least 1300/100 microns of image width or at least 1400/100 microns of image width or at least 1500/100 microns of image width or at least 1600/100 microns of image width or at least 1700/100 microns of image width or at least 1800/100 microns of image width or at least 1900/100 microns of image width or at least 2000/100 microns of image width or at least 2100/100 microns of image width or at least 2200/100 microns of image width or at least 2300/100 microns of image width or at least 2400/100 microns of image width. Still, in another non-limiting embodiment, the body can have a second phase count index of not greater than 4000/100 microns of image width, such as not greater than 3900/100 microns of image width or not greater than 3800/100 microns of image width or not greater than 3700/100 microns of image width or not greater than 3600/100 microns of image width or not greater than 3500/100 microns of image width or not greater than 3400/100 microns of image width or not greater than 3300/100 microns of image width or not greater than 3200/100 microns of image width or not greater than 3100/100 microns of image width or not greater than 3000/100 microns of image width or not greater than 2900/100 microns of image width or not greater than 2800/100 microns of image width or not greater than 2700/100 microns of image width or not greater than 2600/100 microns of image width or not greater than 2500/100 microns of image width. It will be appreciated that the body can have a second phase count index within a range including any of the minimum and maximum values noted above, including for example, within a range of at least 1000/100 microns of image width and not greater than 4000/100 microns of image width, such as within a range including at least 1500/100 microns of image width and not greater than 3000/100 microns of image width, such as within a range including at least 2000/100 microns of image width and not greater than 2500/100 microns of image width. The second phase count index can be measured by sectioning a sample of a material and viewing the sample using a Zeiss Merlin SEM, at a voltage of 2.0 kV, with a working distance between 3-7 mm, to create images of the microstructure for analysis. The image characteristics include an image width of 100 microns and a resolution of 1024 pixels×768 pixels. The image is taken in a manner maximize the contrast between the first phase (e.g., SiC-containing grains) and the second phase material (e.g., alumina), such that the grains of the first phase are darker than the second phase. FIG. 3 provides a gray scale image of a suitable SEM micrograph. Using suitable image analysis software, such as ImageJ 1.48 v available from NIH, crop the image to remove any labels, and adjust the image to increase the brightness of the second phase to facilitate selection of only the white material associated with the second phase. Use the image analysis software to change the image to a binary image (i.e., black and white). See, for example, FIG. 4. Using analysis software, such as Image J, quantify the image statistics using the following approach: Step 1) using Analyze process in ImageJ; step 2) use “Analyze Particles” in ImageJ, and use settings as size (pizel\hat{ }2): 0-infinity and circularity: 0-1; step 3) compare calculated area from output. It will be appreciated that multiple images of randomly selected portions of the microstructure can be analyzed. For example, the microstructural values provided herein can be calculated from at least 3 different SEM images of randomly selected portions of a sample.

In yet another embodiment, the body can have a second phase average area index of at least 2000 pixels/100 microns image width, based on a SEM image of 100 microns in total width and using the resolution noted above. The second phase average area index can be analyzed in the same manner using one or more SEM images taken according to the details provided above. In another embodiment, the second phase average area index can be at least 2500 pixels/100 microns image width or at least 3000 pixels/100 microns image width or at least 3500 pixels/100 microns image width or at least 4000 pixels/100 microns image width or at least 4500 pixels/100 microns image width or at least 5000 pixels/100 microns image width or at least 5500 pixels/100 microns image width or at least 6000 pixels/100 microns image width or at least 6500 pixels/100 microns image width or at least 3000 pixels/100 microns image width or at least 3500 pixels/100 microns image width or at least 4000 pixels/100 microns image width or at least 4500 pixels/100 microns image width or at least 5000 pixels/100 microns image width or at least 5500 pixels/100 microns image width or at least 6000 pixels/100 microns image width or at least 6500 pixels/100 microns image width or at least 7000 pixels/100 microns image width or at least 7500 pixels/100 microns image width or at least 8000 pixels/100 microns image width or at least 8500 pixels/100 microns image width or at least 9000 pixels/100 microns image width or at least 9500 pixels/100 microns image width or at least 10000 pixels/100 microns image width. Still, in one non-limiting embodiment, the body can have a second phase average area index of not greater than 30000 pixels/100 microns image width, such as not greater than 28000 pixels/100 microns image width or not greater than 25000 pixels/100 microns image width or not greater than 22000 pixels/100 microns image width or not greater than 20000 pixels/100 microns image width or not greater than 18000 pixels/100 microns image width or not greater than 15000 pixels/100 microns image width or not greater than 14000 pixels/100 microns image width or not greater than 13000 pixels/100 microns image width or not greater than 12000 pixels/100 microns image width or not greater than 11000 pixels/100 microns image width. It will be appreciated that the second phase average area index can be within a range including any of the minimum and maximum values noted above, including for example, within a range including at least 2000 pixels/100 microns image width and not greater than 30000 pixels/100 microns image width, such as within a range including at least 7000 pixels/100 microns image width and not greater than 20000 pixels/100 microns image width or within a range including at least 9000 pixels/100 microns image width and not greater than 15000 pixels/100 microns image width.

In still another embodiment, the microstructure of the body can be defined by a second phase average size index (pixels²), which defines the average size of the second phase regions based on the SEM image taken to evaluate the second phase count index, except that the image is analyzed using Image J using the same process as noted above for the previous two parameters. A particular second phase average size index can facilitate certain properties of the body. In one embodiment, the body can have a second phase average size index of at least 3.00 pixels², such as at least 3.10 pixels² or at least or at least 3.20 pixels² or at least 3.25 pixels² or at least 3.30 pixels² or at least 3.35 pixels² or at least 3.40 pixels² or at least 3.45 pixels² or at least 3.50 pixels² or at least 3.55 pixels² or at least 3.60 pixels² or at least 3.65 pixels² or at least 3.70 pixels² or at least 3.75 pixels² or at least 3.80 pixels² or at least 3.85 pixels² or at least 3.90 pixels² or at least 3.95 pixels² or at least 4.00 pixels² or at least 4.05 pixels² or at least 4.10 pixels² or at least 4.15 pixels² or at least 4.20 pixels² or at least 4.25 pixels² or at least 4.30 pixels² or at least 4.35 pixels². Still, in one non-limiting embodiment, the second average size index can be not greater than 10.00 pixels², such as not greater than 9.00 pixels² or not greater than 8.00 pixels² or not greater than 7.00 pixels² or not greater than 6.00 pixels² or not greater than 5.75 pixels² or not greater than 5.50 pixels² or not greater than 5.25 pixels² or not greater than 5.00 pixels² or not greater than 4.95 pixels² or not greater than 4.90 pixels² or not greater than 4.85 pixels² or not greater than 4.80 pixels² or not greater than 4.75 pixels² or not greater than 4.70 pixels². It will be appreciated that the second phase average size index can be within a range including any of the minimum and maximum values noted above, including for example, within a range including at least 3.00 pixels² and not greater than 10.00 pixels², such as within a range including at least 3.50 pixels² and not greater than 8.00 pixels² or within a range including at least 4.00 pixels² and not greater than 7.00 pixels².

The body may be formed to be a particularly dense body, which may facilitate certain properties and/or performance. For example, the body may be formed to have at least 90% of theoretical density, such as at least 95% of theoretical density or at least 96% of theoretical density or at least 97% of theoretical density or at least 98% of theoretical density or at least 99% of theoretical density.

In more particular terms, the body may be formed to have a particular value of density, such as at least 2.8 g/cm³ or at least 2.9 g/cm³ or at least 3.0 g/cm³ or at least 3.1 g/cm³ or at least 3.2 g/cm³ or at least 3.3 g/cm³. In one non-limiting embodiment, the body can have a density of not greater than 3.5 g/cm³ or not greater than 3.4 g/cm³ or not greater than 3.3 g/cm³ or not greater than 3.2 g/cm³ or not greater than 3.1 g/cm³ or not greater than 3.0 g/cm³. It will be appreciated that the density of the body can be within a range including any of the minimum and maximum values noted above. Moreover, the density of the body may be some indication of the morphology of the second phase. For example, bodies having an interconnected second phase may have a greater density as compared to those bodies having a discrete second phase that is located in certain regions in the body as described in the embodiments herein.

The body may be formed such that it has a particularly improved strength relative to conventional silicon carbide-containing bodies. For example, the body can have an average strength of at least 700 MPa, such as at least 725 MPa or at least 750 MPa or at least 775 MPa or at least 800 MPa or at least 825 MPa or at least 850 MPa or at least 875 MPa or at least 900 MPa or at least 925 MPa or at least 950 MPa or at least 975 MPa or at least 1000 MPa or at least 1025 MPa or at least 1050 MPa or at least 1075 MPa or at least 1100 MPa or at least 1125 MPa or at least 1150 MPa or at least 1175 MPa or at least 1200 MPa. In still another non-limiting embodiment, the body can have an average strength of not greater than 1200 MPa, such as not greater than 1175 MPa or not greater than 1150 MPa or not greater than 1125 MPa or not greater than 1100 MPa or not greater than 1075 MPa or not greater than 1050 MPa or not greater than 1025 MPa or not greater than 1000 MPa or not greater than 975 MPa or not greater than 950 MPa or not greater than 925 MPa or not greater than 900 MPa or not greater than 875 MPa or not greater than 850 MPa or not greater than 825 MPa or not greater than 800 MPa or not greater than 775 MPa or not greater than 750 MPa or not greater than 725 MPa. It will be appreciated that the body can have an average strength within a range including any of the minimum and maximum values noted above. The strength of the body can be a flexural strength according to a four-point bend test, using configuration B, as defined in ASTM C1161-02C. The average value may be generated by random sampling of bodies from a statistically relevant sample size.

In yet another aspect, the body can have a particular wear value that facilitates the use of the body in wear-resistant applications. For example, the body may have an average wear value of not greater than 1.0 cc, such as not greater than 0.8 cc or not greater than 0.6 cc or not greater than 0.4 cc or not greater than 0.2 cc or not greater than 0.1 cc or not greater than 0.08 cc or not greater than 0.06 cc or not greater than 0.05 cc or not greater than 0.04 cc. Still, in at least one non-limiting embodiment, the body can have an average wear value of at least 0.0001 cc or at least 0.0005 cc or at least 0.001 cc or at least 0.005 cc. It will be appreciated that the body can have an average wear value within a range including any of the minimum and maximum values noted above. The wear value is determined according to ASTM C074/C704 M-15. The average value may be generated by random sampling of bodies from a statistically relevant sample size.

In yet another embodiment, the body may have a particular fracture toughness that facilitates the use of body in certain applications. For example, the body can have an average fracture toughness of at least 3.7 MPa m^{1/2}, such as at least 3.8 MPa m^{1/2} or at least 3.9 MPa m^{1/2} or at least 4.0 MPa m^{1/2} or at least 4.1 MPa m^{1/2} or at least 4.2 MPa m^{1/2} or at least 4.3 MPa m^{1/2} or at least 4.4 MPa m^{1/2} or at least 4.5 MPa m^{1/2} or at least 4.6 MPa m^{1/2} or at least 4.7 MPa m^{1/2} or at least 4.8 MPa m^{1/2} or at least 4.9 MPa m^{1/2} or at least 5 MPa m^{1/2}. Still, in one non-limiting embodiment, the average fracture toughness of the body can be not greater than 7 MPa m^{1/2}, such as not greater than 6.7 MPa m^{1/2} or not greater than 6.3 MPa m^{1/2} or not greater than 6.0 MPa m^{1/2} or not greater than 5.8 MPa m^{1/2} or not greater than 5.5 MPa m^{1/2}. The fracture toughness can be measured by Vickers indentation test using a 1 kg load. The average value may be generated by random sampling of bodies from a statistically relevant sample size. Fracture toughness is measured using the Standard Test Method for measurement of fracture toughness, 2008 and ASTM C 1327-99 at room temperature and using a 1 kg load.

The body may be formed such that it has a particular hardness relative to conventional silicon carbide-containing bodies. For example, the body can have an average hardness (HV_{0.1 kg}) of at least 20 GPa, such as at least 22 GPa or at least 23 GPa or at least 24 GPa or at least 25 GPa or at least 26 GPa or at least 27 GPa or at least 28 GPa or at least 29 GPa or at least 30 GPa. In still another non-limiting embodiment, the body can have an average hardness of not greater than 40 GPa, such as not greater than 38 GPa or not greater than 36 GPa or not greater than 34 GPa or not greater than 32 GPa or not greater than 30 GPa. It will be appreciated that the body can have an average hardness within a range including any of the minimum and maximum values noted above. The hardness of the body can be measured according to the Vickers hardness test using a 1 kg load. The average value may be generated by random sampling of bodies from a statistically relevant sample size. The hardness is measured according to normalized standards hardness test ASTM E1820-09e1.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

### Embodiment 1

A body comprising:

a first phase comprising silicon carbide;

a second phase comprising a metal oxide, wherein the second phase is a discrete intergranular phase located at the grain boundaries of the first phase; and

wherein the body comprises an average strength of at least 700 MPa.

### Embodiment 2

A body comprising:

a first phase comprising silicon carbide and having an average grain size of not greater than 2 microns;

a second phase comprising a metal oxide, wherein the second phase is a discrete intergranular phase located at the grain boundaries of the first phase; and

wherein the body comprises at least one of:

a second phase count index of at least 1000/100 microns image width;

a second phase average area index of at least 2000 pixels/100 microns image width;

a second phase average size index of at least 3.00 pixels2;

or any combination thereof.

### Embodiment 3

A body comprising:

a first phase comprising silicon carbide and having an average grain size of not greater than 2 microns; and

a second phase comprising a metal oxide, wherein the second phase is a discrete intergranular phase and a majority of the second phase is located at triple boundary regions between three or more grains of the first phase.

### Embodiment 4

The body of any one of embodiments 1, 2, and 3, wherein the first phase comprises alpha-phase silicon carbide.

### Embodiment 5

The body of any one of embodiments 1, 2, and 3, wherein the first phase consists essentially of alpha-phase silicon carbide.

### Embodiment 6

The body of any one of embodiments 1, 2, and 3, wherein at least 98% of the first phase comprises alpha-phase silicon carbide.

### Embodiment 7

The body of any one of embodiments 1, 2, and 3, wherein the first phase is free of beta-phase silicon carbide.

### Embodiment 8

The body of any one of embodiments 1, 2, and 3, wherein the body comprises at least 70 wt % of the first phase or at least 75 wt % or at least 80 wt % or at least 85 wt % or at least 90 wt % or at least 92 wt % or at least 93 wt % or at least 94 wt % or at least 95 wt % or at least 96 wt %.

### Embodiment 9

The body of any one of embodiments 1, 2, and 3, wherein the body comprises not greater than 99 wt % of the first phase or not greater than 98 wt % or not greater than 97 wt % or not greater than 96 wt % or not greater than 95 wt % or not greater than 94 wt % or not greater than 93 wt % or not greater than 92 wt % or not greater than 91 wt %.

### Embodiment 10

The body of embodiment 1, wherein the first phase has an average grain size of not greater than 2 microns.

### Embodiment 11

The body of any one of embodiments 2, 3, and 10, wherein the first phase comprises an average grain size of not greater than 1.5 microns or not greater than 1 micron or not greater than 0.8 microns or not greater than 0.5 microns or not greater than 0.3 microns or not greater than 0.2 microns or not greater than 0.1 microns.

### Embodiment 12

The body of embodiment 10, wherein the first phase comprises an average grain size of at least 0.1 microns or at least 0.2 microns or at least 0.4 microns or at least 0.6 microns or at least 0.8 microns or at least 1 micron.

### Embodiment 13

The body of any one of embodiments 1, 2, and 3, wherein the first phase comprises a maximum grain size of not greater than 10 microns or not greater than 9 microns or not greater than 8 microns or not greater than 7 microns or not greater than 6 microns or not greater than 5 microns or not greater than 4 microns or not greater than 3 microns or not greater than 2 microns or not greater than 1 micron.

### Embodiment 14

The body of any one of embodiments 1, 2, and 3, wherein the first phase comprises a maximum grain size of at least 0.5 microns or at least 0.6 microns or at least 0.7 microns or at least 0.8 microns or at least 0.9 microns or at least 1 micron or at least 1.2 microns or at least 1.4 microns or at least 1.5 microns or at least 1.8 microns or at least 2 microns.

### Embodiment 15

The body of any one of embodiments 1, 2, and 3, wherein the metal oxide of the second phase comprises at least one of aluminum, a rare earth element, alkaline earth element, transition metal oxide, or any combination thereof.

### Embodiment 16

The body of any one of embodiments 1, 2, and 3, wherein the metal oxide of the second phase comprises alumina.

### Embodiment 17

The body of any one of embodiments 1, 2, and 3, wherein the metal oxide of the second phase comprises silicon.

### Embodiment 18

The body of any one of embodiments 1, 2, and 3, wherein the metal oxide of the second phase comprises silica.

### Embodiment 19

The body of any one of embodiments 1, 2, and 3, wherein the metal oxide of the second phase comprises an alumina-based phase.

### Embodiment 20

The body of any one of embodiments 1, 2, and 3, wherein the metal oxide of the second phase comprises at least one of a polycrystalline phase, an amorphous phase, or a combination thereof.

### Embodiment 21

The body of any one of embodiments 1, 2, and 3, wherein the metal oxide of the second phase comprises aluminum and silicon and wherein the second phase comprises a first portion including a polycrystalline phase and a second portion comprising an amorphous phase.

### Embodiment 22

The body of any one of embodiments 1, 2, and 3, wherein the metal oxide of the second phase comprises at least 50 wt % alumina or at least 60 wt % alumina or at least 70 wt % alumina or at least 80 wt % alumina or at least 90 wt % alumina or at least 95 wt % alumina or at least 99 wt % alumina.

### Embodiment 23

The body of any one of embodiments 1, 2, and 3, wherein the metal oxide of the second phase consists essentially of alumina.

### Embodiment 24

The body of any one of embodiments 1, 2, and 3, wherein the metal oxide of the second phase is essentially free of alkali elements, alkaline earth elements, transition metal elements, rare earth elements or any combination thereof.

### Embodiment 25

The body of any one of embodiments 1, 2, and 3, wherein the body comprises at least 1 wt % of the second phase or at least 2 wt % or at least 3 wt % or at least 4 wt % or at least 5 wt % or at least 6 wt % or at least 7 wt % or at least 8 wt % or at least 9 wt % of the second phase.

### Embodiment 26

The body of any one of embodiments 1, 2, and 3, wherein the body comprises not greater than 10 wt % of the second phase or not greater than 9 wt % or not greater than 8 wt % or not greater than 7 wt % or not greater than 6 wt % or not greater than 5 wt % or not greater than 4 wt % or not greater than 3 wt % or not greater than 2 wt % of the second phase.

### Embodiment 27

The body of any one of embodiments 1, 2, and 3, wherein the body comprises at least 90% of theoretical density or at least 95% of theoretical density or at least 96% of theoretical density or at least 97% of theoretical density or at least 98% of theoretical density or at least 99% of theoretical density.

### Embodiment 28

The body of any one of embodiments 1, 2, and 3, wherein the body comprises a density of at least 2.8 g/cm3 or at least 2.9 g/cm3 or at least 3.0 g/cm3 or at least 3.1 g/cm3 or at least 3.2 g/cm3 or at least 3.3 g/cm3.

### Embodiment 29

The body of any one of embodiments 1, 2, and 3, wherein the body comprises a density of not greater than 3.5 g/cm3 or not greater than 3.4 g/cm3 or not greater than 3.3 g/cm3 or not greater than 3.2 g/cm3 or not greater than 3.1 g/cm3 or not greater than 3.0 g/cm3.

### Embodiment 30

The body of any one of embodiments 2 and 3, wherein the body comprises an average strength of at least 700 MPa or at least 725 MPa or at least 750 MPa or at least 775 MPa or at least 800 MPa or at least 825 MPa or at least 850 MPa or at least 875 MPa or at least 900 MPa or at least 925 MPa or at least 950 MPa or at least 975 MPa or at least 1000 MPa or at least 1025 MPa or at least 1050 MPa or at least 1075 MPa or at least 1100 MPa or at least 1125 MPa or at least 1150 MPa or at least 1175 MPa or at least 1200 MPa.

### Embodiment 31

The body of any one of embodiments 1, 2, and 3, wherein the average strength of the body is not greater than 1200 MPa or not greater than 1175 MPa or not greater than 1150 MPa or not greater than 1125 MPa or not greater than 1100 MPa or not greater than 1075 MPa or not greater than 1050 MPa or not greater than 1025 MPa or not greater than 1000 MPa or not greater than 975 MPa or not greater than 950 MPa or not greater than 925 MPa or not greater than 900 MPa or not greater than 875 MPa or not greater than 850 MPa or not greater than 825 MPa or not greater than 800 MPa or not greater than 775 MPa or not greater than 750 MPa or not greater than 725 MPa.

### Embodiment 32

The body of any one of embodiments 1 and 3, wherein the second phase is a discrete intergranular phase located at the grain boundaries of the first phase and wherein the body comprises a second phase count index of at least 1000.

### Embodiment 33

The body of any one of embodiments 2 and 32, wherein the second phase count index is at least 1100/100 microns of image width or at least 1200/100 microns of image width or at least 1300/100 microns of image width or at least 1400/100 microns of image width or at least 1500/100 microns of image width or at least 1600/100 microns of image width or at least 1700/100 microns of image width or at least 1800/100 microns of image width or at least 1900/100 microns of image width or at least 2000/100 microns of image width or at least 2100/100 microns of image width or at least 2200/100 microns of image width or at least 2300/100 microns of image width or at least 2400/100 microns of image width.

### Embodiment 34

The body of any one of embodiments 2 and 32, wherein the second phase count index is not greater than 4000/100 microns of image width or not greater than 3900/100 microns of image width or not greater than 3800/100 microns of image width or not greater than 3700/100 microns of image width or not greater than 3600/100 microns of image width or not greater than 3500/100 microns of image width or not greater than 3400/100 microns of image width or not greater than 3300/100 microns of image width or not greater than 3200/100 microns of image width or not greater than 3100/100 microns of image width or not greater than 3000/100 microns of image width or not greater than 2900/100 microns of image width or not greater than 2800/100 microns of image width or not greater than 2700/100 microns of image width or not greater than 2600/100 microns of image width or not greater than 2500/100 microns of image width.

### Embodiment 35

The body of any one of embodiments 1 and 3, wherein the body comprises a second phase average area index of at least 2000 pixels/100 microns of image width.

### Embodiment 36

The body of any one of embodiments 2 and 35, wherein the second phase average area index is at least 2500 pixels/100 microns of image width or at least 3000 pixels/100 microns of image width or at least 3500 pixels/100 microns of image width or at least 4000 pixels/100 microns of image width or at least 4500 pixels/100 microns of image width or at least 5000 pixels/100 microns of image width or at least 5500 pixels/100 microns of image width or at least 6000 pixels/100 microns of image width or at least 6500 pixels/100 microns of image width or at least 3000 pixels/100 microns of image width or at least 3500 pixels/100 microns of image width or at least 4000 pixels/100 microns of image width or at least 4500 pixels/100 microns of image width or at least 5000 pixels/100 microns of image width or at least 5500 pixels/100 microns of image width or at least 6000 pixels/100 microns of image width or at least 6500 pixels/100 microns of image width or at least 7000 pixels/100 microns of image width or at least 7500 pixels/100 microns of image width or at least 8000 pixels/100 microns of image width or at least 8500 pixels/100 microns of image width or at least 9000 pixels/100 microns of image width or at least 9500 pixels/100 microns of image width or at least 10000 pixels/100 microns of image width.

### Embodiment 37

The body of any one of embodiments 2 and 35, wherein the second phase average area index is not greater than 30000 pixels/100 microns of image width or not greater than 28000 pixels/100 microns of image width or not greater than 25000 pixels/100 microns of image width or not greater than 22000 pixels/100 microns of image width or not greater than 20000 pixels/100 microns of image width or not greater than 18000 pixels/100 microns of image width or not greater than 15000 pixels/100 microns of image width or not greater than 14000 pixels/100 microns of image width or not greater than 13000 pixels/100 microns of image width or not greater than 12000 pixels/100 microns of image width or not greater than 11000 pixels/100 microns of image width.

### Embodiment 38

The body of any one of embodiments 1 and 3, wherein second phase average size index of at least 3.00 pixels2.

### Embodiment 39

The body of any one of embodiments 2 and 38, wherein the second phase average size index is at least 3.10 pixels2 or at least or at least 3.20 pixels2 or at least 3.25 pixels2 or at least 3.30 pixels2 or at least 3.35 pixels2 or at least 3.40 pixels2 or at least 3.45 pixels2 or at least 3.50 pixels2 or at least 3.55 pixels2 or at least 3.60 pixels2 or at least 3.65 pixels2 or at least 3.70 pixels2 or at least 3.75 pixels2 or at least 3.80 pixels2 or at least 3.85 pixels2 or at least 3.90 pixels2 or at least 3.95 pixels2 or at least 4.00 pixels2 or at least 4.05 pixels2 or at least 4.10 pixels2 or at least 4.15 pixels2 or at least 4.20 pixels2 or at least 4.25 pixels2 or at least 4.30 pixels2 or at least 4.35 pixels2.

### Embodiment 40

The body of any one of embodiments 2 and 38, wherein the second average size index is not greater than 10.00 pixels2 or not greater than 9.00 pixels2 or not greater than 8.00 pixels2 or not greater than 7.00 pixels2 or not greater than 6.00 pixels2 or not greater than 5.75 pixels2 or not greater than 5.50 pixels2 or not greater than 5.25 pixels2 or not greater than 5.00 pixels2 or not greater than 4.95 pixels2 or not greater than 4.90 pixels2 or not greater than 4.85 pixels2 or not greater than 4.80 pixels2 or not greater than 4.75 pixels2 or not greater than 4.70 pixels2.

### Embodiment 41

The body of any one of embodiments 1 and 3, wherein the body comprises at least one of:

a second phase count index of at least 1000/100 microns image width;

a second phase average area index of at least 2000 pixels/100 microns image width a second phase average size index of at least 3.00 pixels2 or any combination thereof.

### Embodiment 42

The body of any one of embodiments 2 and 41, wherein the body comprises at least one of:

a second phase count index within a range of at least 1000/100 microns image width and not greater than 4000/100 microns image width;

a second phase average area index within a range of at least 2000 pixels/100 microns image width and not greater than 30000 pixels/100 microns image width;

a second phase average size index within a range of at least 3.00 pixels2 and not greater than 10.00 pixels2;

or any combination thereof.

### Embodiment 43

The body of any one of embodiments 2 and 41, wherein the body comprises:

a second phase count index within a range of at least 1000/100 microns image width and not greater than 4000/100 microns image width;

a second phase average area index within a range of at least 2000 pixels/100 microns image width and not greater than 30000 pixels/100 microns image width;

a second phase average size index within a range of at least 3.00 pixels2 and not greater than 10.00 pixels2;

or any combination thereof.

### Embodiment 44

The body of any one of embodiments 1 and 2, wherein a majority of the second phase is located at triple boundary regions between three or more grains of the first phase.

### Embodiment 45

The body of any one of embodiments 3 and 44, wherein at least 55% of the second phase is located at triple boundary regions between three or more grains of the first phase or at least 60% or at least 70% or at least 80% or at least 90% or at least 95% of the second phase is located at triple boundary regions between three or more grains of the first phase.

### Embodiment 46

The body of embodiment 44, wherein essentially all of the second phase is located at triple boundary regions between three or more grains of the first phase.

### Embodiment 47

The body of embodiment 44, wherein not greater than 99% of the second phase is located at triple boundary regions between three or more grains of the first phase.

### Embodiment 48

The body of any one of embodiments 1, 2, and 3, wherein the body comprises an average wear value of not greater than 1.0 cc.

### Embodiment 49

The body of any one of embodiments 1, 2, and 3, wherein the body comprises an average wear value within a range including at least 0.0001 cc and not greater than 0.1 cc.

### Embodiment 50

The body of any one of embodiments 1, 2, and 3, wherein the body comprises an average fracture toughness at least 3.7 MPa m½ and not greater than 7 MPa m½.

### Embodiment 51

The body of any one of embodiments 1, 2, and 3, wherein the body comprises an average hardness (HV0.1 kg) of at least 20 GPa and not greater than 40 GPa.

### Embodiment 52

A method of forming a body comprising:

obtaining a blend of powder material comprising:

a first powder material comprising silicon carbide; and

a second powder material comprising a metal oxide; and

sintering the blend of powder material to form a body comprising:

a first phase comprising silicon carbide;

a second phase comprising a metal oxide, wherein the second phase is a discrete intergranular phase located at the grain boundaries of the first phase; and

wherein the body comprises an average strength of at least 700 MPa.

### Embodiment 53

The method of embodiment 52, further comprising forming blended green particles from the blend of powder material, wherein each of the blended green particles includes the first powder material and the second powder material.

### Embodiment 54

The method of embodiment 53, wherein forming the blended green particles comprises:

creating a slurry of the blend of powder material and a carrier material;

mixing the slurry; and

drying the particles to form blended green particles having an average particle size within a range including at least 20 microns and not greater than 200 microns.

### Embodiment 55

The method of embodiment 54, wherein mixing the slurry includes milling.

### Embodiment 56

The method of embodiment 54, wherein drying includes spray drying.

### Embodiment 57

The method of embodiment 54, further comprising combining the blended green particles to form a green body.

### Embodiment 58

The method of embodiment 57, wherein combining can include at least one process selected from the group consisting of pressing, punching, molding, casting, extruding, curing, or any combination thereof.

### Embodiment 59

The method of embodiment 52, wherein sintering includes pressureless sintering.

### Embodiment 60

The method of embodiment 52, wherein sintering includes pressure-assisted sintering.

### Embodiment 61

The method of embodiment 52, wherein sintering includes hot pressing.

### Embodiment 62

The method of embodiment 61, wherein hot pressing includes applying a sintering pressure of at least 2000 psi and not greater than 5000 psi during sintering at the sintering temperature.

### Embodiment 63

The method of embodiment 61, wherein hot pressing includes applying the sintering pressure for a duration of at least 0.5 hours and not greater than 5 hours at the sintering temperature.

### Embodiment 64

The method of embodiment 52, wherein sintering is conducted at a sintering temperature of at least 1900° C. and not greater than 2100° C.

### Embodiment 65

The method of embodiment 52, wherein sintering is conducted via hot pressing using the conditions including:

a sintering temperature of at least 1900° C. and not greater than 2100° C.

a sintering pressure of least 2000 psi and not greater than 5000 psi during sintering at the sintering temperature; and

a duration of at least 0.5 hours and not greater than 5 hours at the sintering temperature.

### Embodiment 66

The method of embodiment 52, wherein the first powder material comprises an average particle size of not greater than 1.3 microns or not greater than 1 micron or not greater than 0.8 microns or not greater than 0.5 microns or not greater than 0.3 microns or not greater than 0.2 microns or not greater than 0.1 microns.

### Embodiment 67

The method of embodiment 52, wherein the first powder material comprises an average particle size of at least 0.01 microns or at least 0.05 microns or at least 0.08 microns or at least 0.1 microns or at least 0.2 microns or at least 0.3 microns or at least 0.4 microns or at least 0.5 microns.

### Embodiment 68

The method of embodiment 52, wherein the second powder material comprises an average particle size of not greater than 0.9 microns or not greater than 0.8 microns or not greater than 0.7 microns or not greater than 0.6 microns or not greater than 0.5 microns or not greater than 0.4 microns or not greater than 0.3 microns or not greater than 0.2 micron or not greater than 0.1 microns.

### Embodiment 69

The method of embodiment 52, wherein the second powder material comprises an average particle size of at least 0.01 microns or at least 0.05 microns or at least 0.08 microns or at least 0.1 microns.

### Embodiment 70

The method of embodiment 52, wherein the first powder material comprises a maximum particle size of not greater than 5 microns or not greater than 4.5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.5 microns or not greater than 0.2 microns.

### Embodiment 71

The method of embodiment 52, wherein the first powder material comprises a maximum particle size of at least 0.01 microns or at least 0.05 microns or at least 0.08 microns or at least 0.1 microns or at least 0.2 microns or at least 0.5 microns or at least 0.8 microns or at least 1 micron or at least 1.5 microns or at least 2 microns or at least 2.5 microns or at least 3 microns or at least 3.5 microns.

### Embodiment 72

The method of embodiment 52, wherein the second powder material comprises a maximum particle size of not greater than 5 microns or not greater than 1 micron.

### Embodiment 73

The method of embodiment 52, wherein the second powder material comprises a maximum particle size of at least 0.1 microns or at least 0.5 microns or at least 1 micron.

### Embodiment 74

The method of embodiment 52, wherein the first powder material comprises alpha-phase silicon carbide.

### Embodiment 75

The method of embodiment 52, wherein the first powder material includes at least 80 wt % of alpha-phase silicon carbide or at least 82 wt % or at least 85 wt % or at least 87 wt % or at least 90 wt % or at least 92 wt % or at least 95 wt % or at least 97 wt % or at least 99 wt %.

### Embodiment 76

The method of embodiment 52, wherein the first powder material consists essentially of alpha-phase silicon carbide.

### Embodiment 77

The method of embodiment 52, wherein the first powder material is essentially free of beta-phase silicon carbide.

### Embodiment 78

The method of embodiment 52, wherein the first powder material comprises particles, and wherein a portion of the particles include an oxidation layer overlying at least a portion of an exterior surface.

### Embodiment 79

The method of embodiment 78, wherein the oxidation layer comprises an oxide compound.

### Embodiment 80

The method of embodiment 78, wherein the oxidation layer comprises silicon.

### Embodiment 81

The method of embodiment 78, wherein the oxidation layer comprises SiOx, wherein X has a value within a range between 1 and 3.

### Embodiment 82

The method of embodiment 78, wherein the portion includes at least 10 wt % of the total particle of the first powder material or at least 20 wt % or at least 30 wt % or at least 40 wt % or at least 50 wt % or at least 60 wt % or at least 70 wt % or at least 80 wt % or at least 90 wt %.

### Embodiment 83

The method of embodiment 78, wherein essentially all of the particles of the first powder material include the oxidation layer.

### Embodiment 84

The method of embodiment 52, wherein the first powder material includes not greater than 20 wt % of beta-phase silicon carbide or not greater than 18 wt % or not greater than 16 wt % or not greater than 14 wt % or not greater than 12 wt % or not greater than 10 wt % or not greater than 8 wt % or not greater than 6 wt % or not greater than 4 wt % or not greater than 2 wt % or not greater than 1 wt % or not greater than 0.5 wt % or not greater than 0.1 wt %.

### Embodiment 85

The method of embodiment 52, wherein the blend includes at least 70 wt % of the first powder material or at least 75 wt % or at least 80 wt % or at least 85 wt % or at least 90 wt % or at least 92 wt % or at least 93 wt % or at least 94 wt % or at least 95 wt % or at least 96 wt % or at least 98 wt %.

### Embodiment 86

The method of embodiment 52, wherein the blend includes not greater than 99 wt % of the first powder material or not greater than 98 wt % or not greater than 97 wt % or not greater than 96 wt % or not greater than 95 wt % or not greater than 94 wt % or not greater than 93 wt % or not greater than 92 wt % or not greater than 91 wt %.

### Embodiment 87

The method of embodiment 52, wherein the blend includes at least 1 wt % of the second powder material or at least 2 wt % or at least 3 wt % or at least 4 wt % or at least 5 wt % or at least 6 wt % or at least 7 wt % or at least 8 wt % or at least 9 wt %.

### Embodiment 88

The method of embodiment 52, wherein the blend includes not greater than 10 wt % of the second powder material or not greater than 9 wt % or not greater than 8 wt % or not greater than 7 wt % or not greater than 6 wt % or not greater than 5 wt % or not greater than 4 wt % or not greater than 3 wt % or not greater than 2 wt %.

### Embodiment 89

The method of embodiment 52, wherein the blend comprises a ratio (C1/C2) of the content of the first powder material (C1) as measured in weight percent compared to the content of the second powder material (C2) as measured in weight percent, wherein the ratio (C1/C2) is at least 9 or at least 12 or at least 14 or at least 16 or at least 18 or at least 20 or at least 22 or at least 24 or at least 26 or at least 28.

### Embodiment 90

The method of embodiment 52, wherein the blend comprises a ratio (C1/C2) of the content of the first powder material (C1) as measured in weight percent compared to the content of the second powder material (C2) as measured in weight percent, wherein the ratio (C1/C2) is not greater than 55 or not greater than 50 or not greater than 45 or not greater than 40 or not greater than 35 or not greater than 30 or not greater than 28 or not greater than 26 or not greater than 24 or not greater than 22.

### Embodiment 91

The method of embodiment 52, wherein the second powder material comprises at least one of aluminum, a rare earth element, alkaline earth element, transition metal oxide, or any combination thereof.

### Embodiment 92

The method of embodiment 52, wherein the metal oxide of the second powder material comprises alumina.

### Embodiment 93

The method of embodiment 52, wherein the metal oxide of the second powder material comprises silicon.

### Embodiment 94

The method of embodiment 52, wherein the metal oxide of the second powder material comprises silica.

### Embodiment 95

The method of embodiment 79, wherein the metal oxide of the second powder material consists essentially of alumina.

### Embodiment 96

The method of embodiment 52, wherein the metal oxide of the second powder material comprises at least 50 wt % alumina or at least 60 wt % alumina or at least 70 wt % alumina or at least 80 wt % alumina or at least 90 wt % alumina or at least 95 wt % alumina or at least 99 wt % alumina.

### EXAMPLE

A series of samples were made using the following process. A first powder material was obtained, which was primarily alpha silicon carbide having an average particle size of 0.6 μm, commercially available as Sintex13 from Saint-Gobain. The silicon carbide powder included some content of an oxidation film comprising silicon and oxygen present on at least a portion of the surface of the first powder material. A second powder material was blended with the first powder material. The second powder material was alpha alumina having an average particle size between 100-200 nm, commercially available as AKP53 from Sumitomo Corporation. The blend included 96 wt % of the first powder material and 4 wt % of the second powder material.

The blend was mixed in an acoustic mixer using 82 wt % DI water, SiC media, 3.33 wt % PVA (21% sol), 1 wt % PEG400 (Carbowax400), and 0.7 wt % TEA (all percentages are relative to the SiC).

After mixing the blend, the material was spray dried on a Yamato DL410 spray-dryer. The spray dried particles were screened through a 100 micron mesh, such that the blended green particles had an average particle size of approximately 50 to 60 microns and a maximum particle size of approximately 100 microns.

After forming and sieving the blended green particles, the particles are placed in a mold of a desired size and shape and subject to a hot pressing operation. Hot pressing is conducted at a sintering pressure of approximately 3000 psi on a 4 in² sample at a sintering temperature of 1950° C.-2050° C., for a duration of 0.5 hours or 1 hour, depending upon the sample. Sintering is conducted in an inert atmosphere to form the finally-formed body. Hot pressing is a uniaxial pressing operation conducted on a GCA machine, commercially available from TFS Technologies. Table 1 provides the sintering temperatures, sintering duration, average strength and standard deviation of the strength values for the samples (S1-S8)

TABLE 1

| | Sintering | Sintering | Average | |
|---|---|---|---|---|
| Sample | Temp. | Duration | Strength | |
| ID | (° C.) | (hrs.) | (MPa) | Std. Dev. |
| S1 | 1950 | 0.5 | 363 | 15 |
| S2 | 1950 | 1 | 370 | 22 |
| S3 | 2000 | 0.5 | 424 | 19 |
| S4 | 2000 | 1 | 532 | 42 |
| S5 | 2050 | 0.5 | 560 | 15 |
| S6 | 2050 | 1 | 729 | 32 |
| S7 | 2100 | 0.5 | 561 | 53 |
| S8 | 2100 | 1 | 612 | 63 |

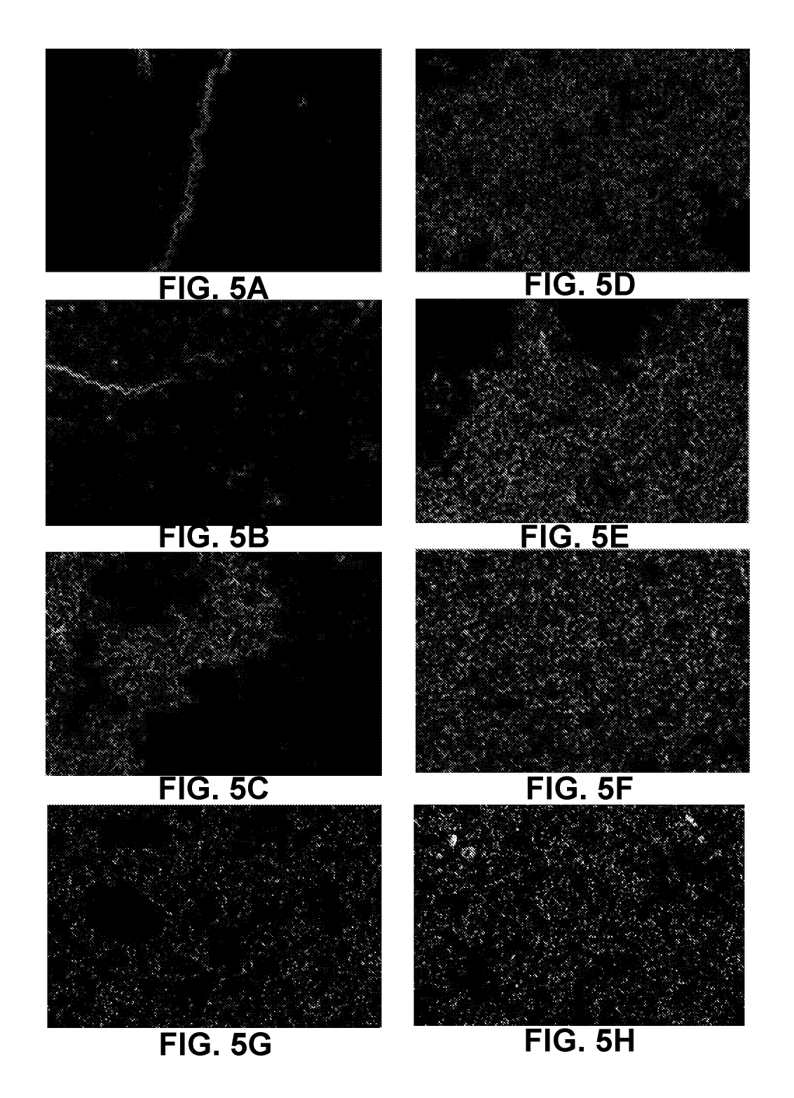

FIGS. 5A-5H include cross-sectional SEM images taken of samples S1-S8, respectively.

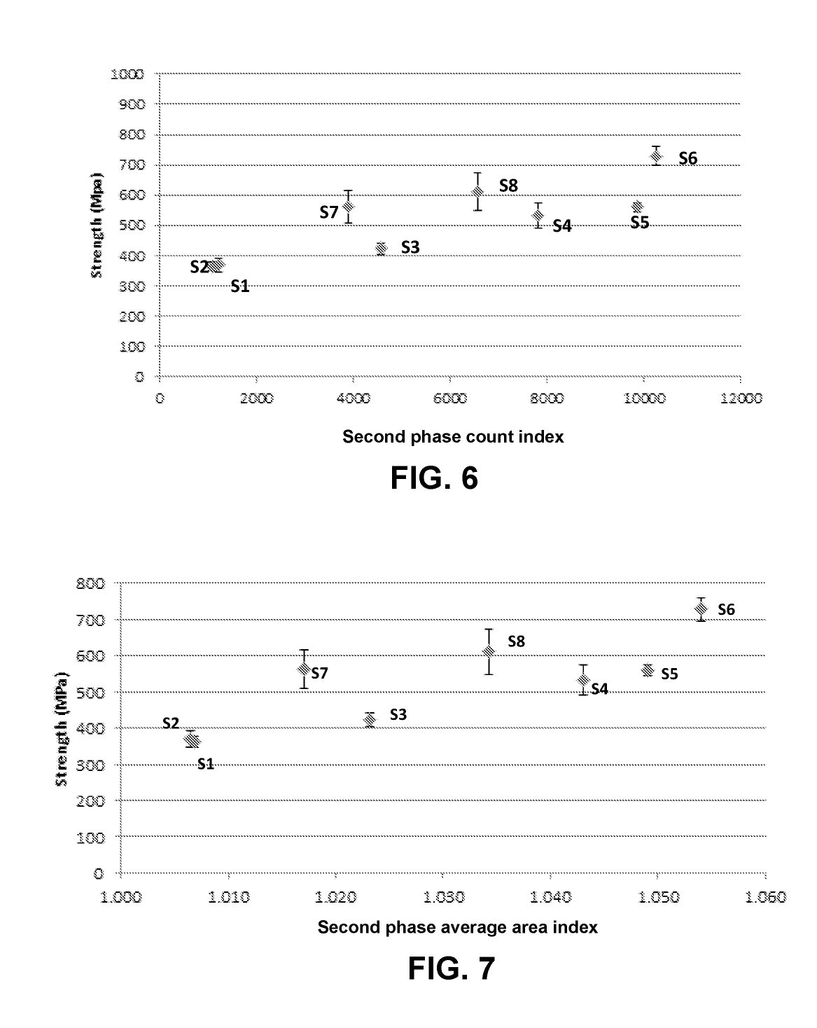

FIG. 6 includes a plot of second phase count index factor versus strength for samples S1-S8. FIG. 7 includes a plot of second phase average area index versus strength for samples S1-S 8.

Sample S1 had an average grain size of approximately 1.10 microns and a maximum grain size of approximately 3.86 microns. The body included approximately 96 wt % of a first phase including silicon carbide and approximately 4 wt % of the second phase. The density of the body was 98-99% theoretical density.

Sample S2 had an average grain size of approximately 1.15 microns and a maximum grain size of approximately 4.4 microns. The body included approximately 96 wt % of a first phase including silicon carbide and approximately 4 wt % of the second phase. The density of the body was 98-99% theoretical density.

Sample S3 had an average grain size of approximately 1.15 microns and a maximum grain size of approximately 4.4 microns. The body included approximately 96 wt % of a first phase including silicon carbide and approximately 4 wt % of the second phase. The density of the body was 98-99% theoretical density.

Sample S4 had an average grain size of approximately 1.27 microns and a maximum grain size of approximately 4.71 microns. The body included approximately 96 wt % of a first phase including silicon carbide and approximately 4 wt % of the second phase. The density of the body was 98-99% theoretical density.

Sample S5 had an average grain size of approximately 1.41 microns and a maximum grain size of approximately 5.84 microns. The body included approximately 96 wt % of a first phase including silicon carbide and approximately 4 wt % of the second phase. The density of the body was 98-99% theoretical density.

Sample S6 had an average grain size of approximately 1.10 microns and a maximum grain size of approximately 4 microns. The body included approximately 96 wt % of a first phase including silicon carbide and approximately 4 wt % of the second phase. The density of the body was 98-99% theoretical density, an average strength of approximately 440 MPa, an average wear value of 0.04 cc, and an average toughness of approximately 4.6 MPa m^{1/2}.

Sample S7 had an average grain size of approximately 1.09 microns and a maximum grain size of approximately 4.35 microns. The body included approximately 96 wt % of a first phase including silicon carbide and approximately 4 wt % of the second phase. The density of the body was 98-99% theoretical density.

Sample S8 had an average grain size of approximately 1.29 microns and a maximum grain size of approximately 7.79 microns. The body included approximately 96 wt % of a first phase including silicon carbide and approximately 4 wt % of the second phase. The density of the body was 98-99% theoretical density.

Certain prior art has disclosed that silicon carbide bodies with some content of metal oxide may be formed using conventional techniques to form bodies having conventional microstructures. See for example, Singhal and Lange, “Effect of Alumina Content on the Oxidation of Hot-Pressed Silicon Carbide” Metallurgy and Metals Processing. Pp. 433-435. See also, Lange, “Hot-pressing behavior of Silicon Carbide powders with additions of Aluminum Oxide.” Journal of Materials Science. Vol. 10, 1975. See also, Suzuki. “Improvement in the oxidation resistance of liquid phase sintered silicon carbide with aluminum oxide additions.” Ceramics International. Vol. 31, 2005. However, the foregoing embodiments are believed to be distinct from such conventional processes and articles. First, it has been noted and is surprising that the bodies of the present embodiments are capable of being formed to have a particular microstructure using significantly less sintering pressure at the sintering duration compared to conventional techniques. Moreover, without wishing to be tied to a particular theory, it is thought that the combination of processing parameters facilitates formation of a body having the combination of features of the embodiments herein. Notably, the bodies of the embodiments herein can be processes in a particular manner to create a unique microstructure, which may also facilitate one or more unique properties of the bodies.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

1.-15. (canceled)

16. A body comprising:
a first phase comprising silicon carbide;
a second phase comprising a metal oxide, wherein the second phase is a discrete intergranular phase located at the grain boundaries of the first phase; and
wherein the body comprises an average strength of at least 700 MPa.

17. The body of claim 16, wherein the body comprises at least 70 wt % and not greater than 99 wt % of the first phase for the total weight of the body, and wherein the first phase comprises alpha-phase silicon carbide.

18. The body of claim 16, wherein the first phase has an average grain size of not greater than 2 microns.

19. The body of claim 16, wherein the first phase comprises a maximum grain size of not greater than 10 microns.

20. The body of claim 16, wherein wherein the body comprises at least 1 wt % and not greater than 10 wt % of the second phase for the total weight of the body, and wherein the metal oxide of the second phase comprises aluminum and silicon.

21. The body of claim 16, wherein the body comprises an average strength of at least 700 MPa.

22. The body of claim 16, wherein the body comprises an average strength of at least 700 MPa and not greater than 1200 MPa.

23. The body of claim 16, wherein the second phase is a discrete intergranular phase located at the grain boundaries of the first phase, and wherein the body comprises a second phase count index of at least 1000.

24. The body of claim 23, wherein the second phase count index is at least 1100/100 microns of image width and not greater than 4000/100 microns of image width.

25. The body of claim 23, wherein the second phase average area index is at least 2500 pixels/100 microns of image width and not greater than 30000 pixels/100 microns of image width.

26. The body of claim 23, wherein the second phase average size index is at least 3.10 pixels² and not greater than 10.00 pixels².

27. The body of claim 23, wherein the body comprises at least one of:
a second phase count index within a range of at least 1000/100 microns image width and not greater than 4000/100 microns image width;
a second phase average area index within a range of at least 2000 pixels/100 microns image width and not greater than 30000 pixels/100 microns image width;
a second phase average size index within a range of at least 3.00 pixels² and not greater than 10.00 pixels²;
or any combination thereof.

28. The body of claim 16, wherein the body comprises an average wear value within a range including at least 0.0001 cc and not greater than 0.1 cc, and further wherein the body comprises an average fracture toughness at least 3.7 MPa m½ and not greater than 7 MPa m^{1/2}, and further wherein the body comprises an average hardness (HV_{0.1 kg}) of at least 20 GPa and not greater than 40 GPa.

29. A body comprising:
a first phase comprising silicon carbide and having an average grain size of not greater than 2 microns;
a second phase comprising a metal oxide, wherein the second phase is a discrete intergranular phase located at the grain boundaries of the first phase; and
wherein the body comprises at least one of:
a second phase count index of at least 1000/100 microns image width;
a second phase average area index of at least 2000 pixels/100 microns image width;
a second phase average size index of at least 3.00 pixels²;
or any combination thereof.

30. The body of claim 29, wherein the body comprises at least 70 wt % and not greater than 99 wt % of the first phase for the total weight of the body, and wherein the first phase comprises alpha-phase silicon carbide.

31. The body of claim 29, wherein the first phase has an average grain size of not greater than 2 microns.

32. The body of claim 29, wherein the first phase comprises a maximum grain size of not greater than 10 microns.

33. The body of claim 29, wherein wherein the body comprises at least 1 wt % and not greater than 10 wt % of the second phase for the total weight of the body, and wherein the metal oxide of the second phase comprises aluminum and silicon.

34. The body of claim 29, wherein the body comprises an average strength of at least 700 MPa.

35. A method of forming a body comprising:
obtaining a blend of powder material comprising:
a first powder material comprising silicon carbide; and
a second powder material comprising a metal oxide; and
sintering the blend of powder material to form a body comprising:
a first phase comprising silicon carbide;
a second phase comprising a metal oxide, wherein the second phase is a discrete intergranular phase located at the grain boundaries of the first phase; and
wherein the body comprises an average strength of at least 700 MPa.
